(19) United States
(12) Patent Application Publication
(10) Pub. No.: US 2026/0078998 A1
(43) Pub. Date: Mar. 19, 2026

(54) MEASURING APPARATUS FOR A TRAILER VEHICLE FOR DETERMINING AN ARTICULATION ANGLE, MEASURING SYSTEM, TRAILER VEHICLE

(71) Applicant: ZF CV Systems Global GmbH, Bern (CH)

(72) Inventors: Axel Stender, Hameln (DE); Norbert Witte, Lauenau (DE)

(21) Appl. No.: 19/394,706

(22) Filed: Nov. 19, 2025

Related U.S. Application Data
(63) Continuation of application No. PCT/EP2024/063276, filed on May 14, 2024.

(30) Foreign Application Priority Data
Jun. 2, 2023 (DE) 10 2023 114 573.8

(51) Int. Cl. G01B 7/30; B62D 53/08

(52) U.S. Cl. CPC G01B 7/30; B62D 53/0842

(57) ABSTRACT

A measuring device for a trailer vehicle for determining an articulation angle between a towing vehicle and the trailer vehicle includes a kingpin and a sensor device. The sensor device is configured to measure a deflection of the kingpin in two directions caused by a force between the towing vehicle and the trailer vehicle. A measuring system include the measuring device. A vehicle includes the measuring device and/or the measuring system.

### CROSS-REFERENCE TO RELATED APPLICATIONS

Th This application is a continuation application of international patent application PCT/EP2024/063276, filed May 14, 2024 designating the United States and claiming priority from German application 10 2023 114 573.8, filed Jun. 2, 2023, and the entire content of both applications is incorporated herein by reference.

### TECHNICAL FIELD

The disclosure relates to a measuring device for a trailer vehicle for determining an articulation angle between a towing vehicle and the trailer vehicle, wherein the measuring device includes a kingpin and a sensor device. The disclosure also relates to a measuring system for a trailer vehicle, including a measuring device and a controller connected to the sensor device, and also to a trailer vehicle.

### BACKGROUND

In particular, the disclosure relates to the field of semitrailers with an electrically driveable axle and/or automatic tractor axle control, that is, in particular trailer vehicles with an electrically driveable axle, and vehicles of Level 4 or higher according to SAE J3016 “Taxonomy and Definitions for Terms Related to Driving Automation Systems for On-Road Motor Vehicles”dated Apr. 30, 2021.

A semitrailer or the trailer vehicle and the towing vehicle with a fifth-wheel coupling can be connected to each other by a kingpin to form a multi-unit vehicle. Accordingly, forces that can reflect forces between the towing vehicle and the trailer vehicle can act on the kingpin during operation. Forces of this kind can be caused by a load, that is, a mass, of the semitrailer, but also by load changes or driving dynamics. For example, a force with a component counter to the direction of travel can act on the kingpin during braking and a force with a component in the direction of travel can act on the kingpin during acceleration.

EP 0 548 487 A2 discloses a means for measuring a deformation of a component. In order to reduce the complexity of a deformation measurement, an arrangement including a transmission element and one or two sensors is provided in the component. The sensor is configured with a measurement surface which emits an electrical signal that is dependent on a deformation of the measurement surface. The transmission element is supported on a sensor at one end and on the component or the other sensor at the other end. In the event of a deformation of the component, the distance between the support points of the transmission element changes. This change in distance creates a deformation of the measurement surface of the sensor, this deformation being interpreted as a measure of the deformation of the component.

Therefore, a method is known with which the deflection of a supporting bolt of a fifth-wheel coupling can be detected by way of a sensing means in the supporting bolt.

It is also known to fasten the kingpin via sensing screws, for example, and to measure the forces acting on the screws.

WO 2022/074010 A1 discloses a screw with strain gauges, and a kingpin and a jaw coupling. The sensing screw with a screw head, a screw shank adjoining the screw head along a screw axis and a thread formed on the screw shank has a measuring means with a strain gauge which is arranged along or in the interior of the screw shank and detects strains of the screw shank in the direction of the screw axis, wherein the measuring means has at least two electrical connections, which, as contact points, lie on an outer side of the sensing screw, and in particular are arranged in such a way that, when the sensing screw is introduced into a socket, they come into contact with two correlating electrical contacts of the socket. A kingpin for a fifth-wheel coupling is also disclosed, the kingpin having a pin shaft, at the first end of which a pin head is arranged and at the second end of which a fastening flange is arranged, wherein the fastening flange has at least one screw hole, and having at least one screw connection, wherein the sensing screw of this screw connection projects through the screw hole.

DE 10 2023 101 340.8, which had not yet been published on the filing date of the present disclosure, describes a device for measuring a force acting on a kingpin of a semitrailer, wherein the device includes the kingpin and a sensor device, and the sensor device is configured to determine a deflection of the kingpin caused by the force.

This makes it possible to measure at the kingpin the horizontal or radial forces acting between the trailer vehicle and the towing vehicle, which forces can act between the semitrailer and the towing vehicle in particular due to braking or acceleration.

In particular for an automated driving function, information relating to forces acting on the kingpin may have to be taken into account in order, for example, to be able to control deceleration of the trailer vehicle and/or driving of the trailer vehicle by a control system of the trailer vehicle. In this case, an articulation angle between the towing vehicle and the trailer vehicle may be necessary for an autonomous automated function of the trailer vehicle, that is, for an automated function which the trailer vehicle carries out without an input from the towing vehicle.

EP 0 433 858 A2 discloses an articulation angle sensor in which a magnet is fitted to a kingpin and the articulation angle is determined via a Hall sensor on the towing vehicle.

In this case, however, components are required in the towing vehicle and in the trailer vehicle in order to determine the articulation angle. Therefore, an autonomous solution only for the trailer vehicle cannot be implemented.

DE 10 2017 110 520 A1 discloses a trailer for a vehicle. Here, the trailer has at least one sensor which is configured to directly or indirectly measure a force acting on the trailer. The trailer also has an electric motor, which is coupled to at least one wheel of the trailer. A control unit is configured to actuate the electric motor. Here, a driving state of the trailer is determined based on data determined by the at least one sensor, and the electric motor is operated in motor mode, in generator mode or in idle mode as a function of the determined driving state. The semitrailer can have one or more sensors, which are mechanically connected to the kingpin. This may be understood to mean that the sensor or the sensors is/are fitted, for example directly, on the kingpin or in the vicinity thereof. Strains or forces occurring at the kingpin can be measured via the sensor while the semitrailer is moving. The sensors can be configured to measure forces in one plane which act on the kingpin while the semitrailer is moving. A driving state of the semitrailer combination can be determined on the basis of the measured forces in the plane. It is possible, for example, to determine whether the semitrailer combination is traveling straight ahead or around a bend and/or whether the semitrailer combination is moving at a constant speed or accelerating. The sensors may be, for example, strain gauges (DMS), which are fitted to the shank of the kingpin for this purpose.

### SUMMARY

It is an object of the disclosure to provide for alternative autonomous determination of an articulation angle between a towing vehicle and a trailer vehicle by an alternative sensing means in the trailer vehicle.

According to an aspect of the disclosure, a measuring device for a trailer vehicle for determining an articulation angle between a towing vehicle and the trailer vehicle is provided, wherein the measuring device includes a kingpin and a sensor device and the sensor device is configured to measure a deflection of the kingpin in two directions caused by a force between the towing vehicle and the trailer vehicle.

It has been identified that a deformation of the kingpin can take place due to the force acting on the kingpin since the kingpin typically consists of a material, for example metal, which permits an, in particular elastic, deformation due to an action of the force. The force acting on the kingpin can be determined by the sensor device via the deformation or in particular deflection caused by the force. It has been identified here that the deflection typically has a defined relationship to the acting force. It is thus possible to infer the acting force from the deflection of the kingpin.

In order that the articulation angle can be determined, the measuring device is configured to measure the force or the deflection in the two directions: In other words, the measuring device is configured to measure components of the force or the deflection in two mutually different, that is, linearly independent, directions. The direction of the force can be determined by measuring the components in the two different directions. It has been identified here that a plane in which the direction of the force can be measured is spanned by the two directions in which the deflections can be measured. Here, the direction of the force can be used to determine the articulation angle.

This allows direct measurement of the deflection of the kingpin and thus direct determination of the force acting on the kingpin, which allows reliable and precise measurement. Indirect determination of the force acting on the kingpin by acting forces on one or more sensing screws or bolts, which for example fasten a fastening flange of the kingpin to a skid plate of the semitrailer, can therefore be dispensed with.

In other words, a measuring device for determining the articulation angle between the towing vehicle and the trailer vehicle is proposed, wherein the deflection due to the tensile or compressive forces between the towing vehicle and the trailer vehicle can be measured in two directions in the kingpin and, as a result, the articulation angle can be calculated. It is effectively possible to measure dynamic articulation angles during travel by way of sensing the forces between the towing vehicle and the trailer vehicle.

A significant advantage is that no wearing sensor parts are used. Autonomous functions for the trailer become possible on the basis of the articulation angle between the truck and the trailer determined by the measuring device in the trailer.

Optionally, the two directions enclose an angle of 80° to 100° with each other. It has been identified here that an angle of 80° to 100° between the two directions can enable particularly effective and substantially or completely decoupled detection of the components of the deflection. In addition, an angle of 90° between the two directions can simplify the calculation of the articulation angle using trigonometric relationships.

Optionally, the sensor device has two sensor elements for measuring the deflection in one of the two directions in each case. Here, each of the sensor elements is configured to detect the deflection of the kingpin in one of the directions. In this case, each of the sensor elements can be configured analogously to the sensor device known from DE 10 2023 101 340.8, wherein, however, the two sensor elements are provided in order to be able to determine the force application angle on the kingpin and therefore the dynamic articulation angle. In addition, two sensor elements allow redundancy in order to check the plausibility of a force and/or its magnitude independently of direction and/or to detect the force/magnitude in the event of failure of one of the sensor elements.

Optionally, the trailer vehicle defines a forward direction of travel and the two sensor elements are arranged in such a way that a straight line between the kingpin and one of the sensor elements encloses a second angle of 40° to 50° with the forward direction of travel. It has been identified here that an angle of 40° to 50° between the respective straight line and the forward direction of travel can enable particularly effective detection of the components of the deflection in a manner substantially or completely decoupled from each other. In addition, an angle of 45° between the respective straight line and the forward direction of travel can simplify the calculation of the articulation angle using trigonometric relationships.

Optionally, the kingpin has two openings and the sensor device is arranged in the two openings. Owing to the openings, it is possible to fit components of the sensor device, in particular of the sensor elements, in a protected manner. In the event of a deflection of the kingpin, the openings are also deformed, which makes it possible for the deflection of the kingpin to be able to be determined in the openings and/or by a deformation of the openings. Here, the kingpin has a longitudinal axis and the openings can be arranged parallel to the longitudinal axis. In other words, the openings can be arranged in such a way that the openings each extend parallel to the longitudinal axis. The longitudinal axis can be a rotation axis of the kingpin and in particular of the pin shank and of the pin head. There is therefore a distance between the respective opening and the longitudinal axis, which distance can influence the sensitivity of the measurement of the deflection. As an alternative or in addition, the kingpin has a neutral axis and the openings are each arranged outside the neutral axis. In this case, the neutral axis may be referred to as a zero line, as in strength of materials theory. The neutral axis is that line or layer of a cross section of the kingpin of which the length does not change in the event of deflection, or more generally twisting and/or bending. In the neutral axis, the deflection does not cause any tensile or compressive stress. Outside the neutral axis, the deflection causes a change in length and thus a tensile and/or compressive stress. The neutral axis can correspond to a longitudinal axis of the kingpin. The arrangement of the openings outside the neutral axis enables reliable measurement of the deflection. The distance of the respective opening from the neutral axis can influence the sensitivity of a measurement and/or of the sensor device.

Optionally, the kingpin has a pin shank and the openings are arranged within the pin shank. The pin shank can typically form a relevant part of the deflection, as a result of which the openings within the pin shank can likewise be deflected, which enables effective and reliable determination of the deflection of the kingpin.

Optionally, the kingpin has a pin head and the openings each extend through the pin shank into the pin head. The pin head can form an end of the kingpin and therefore undergo a comparatively large displacement in the event of a deflection of the kingpin, which displacement can contribute to effective and reliable determination of the deflection of the kingpin.

According to an aspect of the disclosure, a measuring system for a trailer vehicle is provided. The measuring system includes the above-described measuring device and a controller connected to the sensor device, wherein the controller is configured to determine, on the basis of the deflection of the kingpin in two directions, an articulation angle between the towing vehicle and the trailer vehicle. It has been identified here that, by detecting the deflection in two, in particular linearly independent, directions, it is possible to determine components of the force acting on the kingpin. The direction of the force and therefore the articulation angle can be inferred on the basis of the force or on the basis of the components thereof. Optionally, the measuring device includes one or more of the above-described optional and/or advantageous features in order to achieve an associated technical effect.

Optionally, the controller is configured to determine the articulation angle as a function of a quotient of a first deflection in a first direction of the two directions and a second deflection in a second direction of the two directions and/or an inverse trigonometric function of the quotient. It has been identified here that the quotient of the first deflection and the second deflection can correspond to a ratio of components of the force acting in the plane spanned by the two directions. By considering an inverse trigonometric function, it is possible to calculate an angle which can correspond to the articulation angle from the two directions of the deflection and therefore the force.

According to an aspect of the disclosure, a trailer vehicle is provided. The trailer vehicle includes the above-described measuring device and/or the above-described measuring system. Optionally, the measuring device and/or the measuring system include/includes one or more of the above-described optional and/or advantageous features in order to achieve an associated technical effect.

### BRIEF DESCRIPTION OF DRAWINGS

The invention will now be described with reference to the drawings wherein:

FIG. 1 shows a schematic illustration of a side view of a multi-unit vehicle including a trailer vehicle according to an aspect of the disclosure;

FIG. 2 shows a further schematic illustration of a side view of a multi-unit vehicle including a trailer vehicle according to an aspect of the disclosure;

FIG. 3 shows a schematic illustration of a top view of a multi-unit vehicle including a trailer vehicle according to an aspect of the disclosure;

FIG. 4 shows a schematic sectional illustration of a measuring device as per an embodiment according to an aspect of the disclosure; and,

FIG. 5 shows a schematic illustration of a kingpin having a measuring device as per an embodiment according to an aspect of the disclosure and acting and measurable forces.

### DETAILED DESCRIPTION

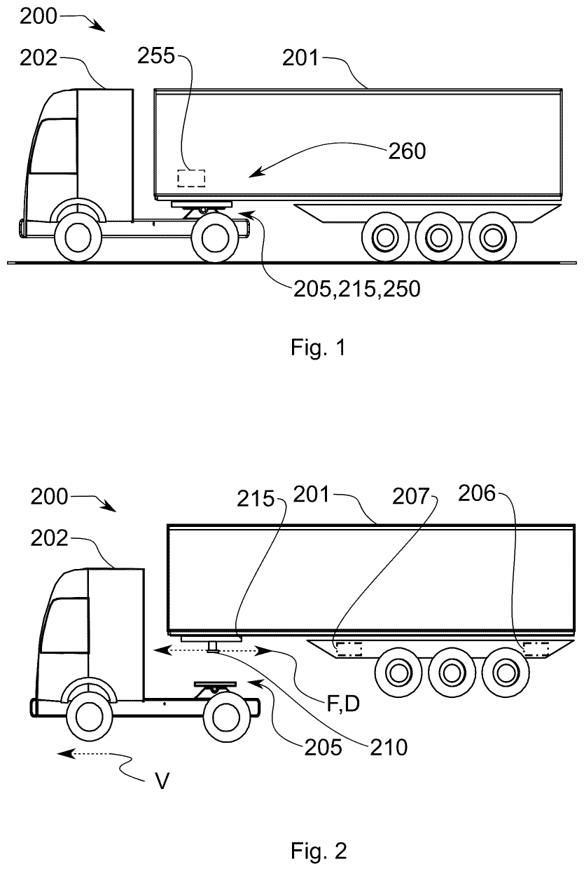

FIG. 1 shows a schematic illustration of a multi-unit vehicle 200 including a trailer vehicle 201 according to an aspect of the disclosure. The multi-unit vehicle 200 is a utility vehicle and a land vehicle.

The multi-unit vehicle 200 includes a towing vehicle 202 and a trailer vehicle 201, configured here as a semitrailer. The towing vehicle 202 is configured to be coupled to the trailer vehicle 201 in order to be able to pull the trailer vehicle 201. The towing vehicle 202 has a fifth-wheel coupling 205 for this purpose.

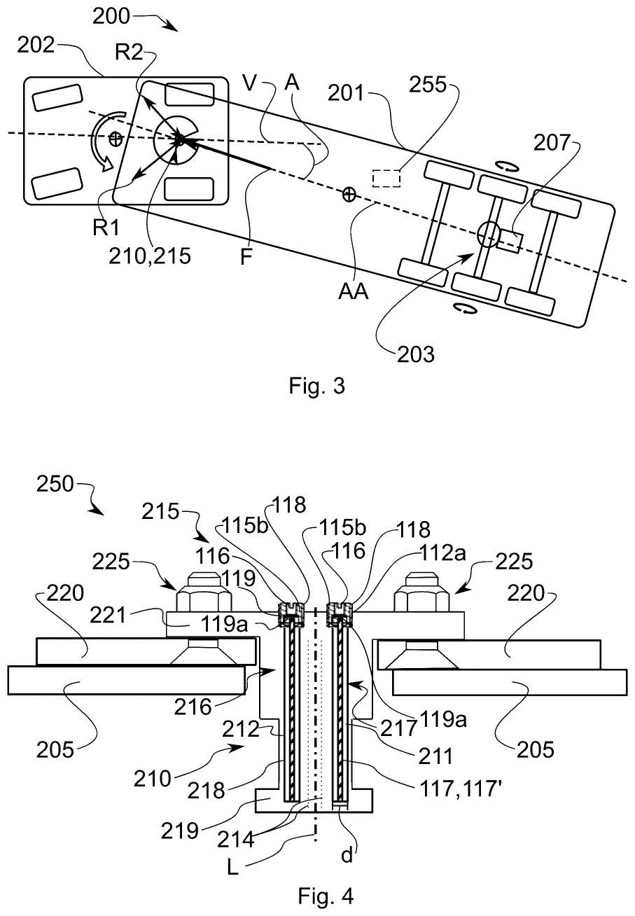

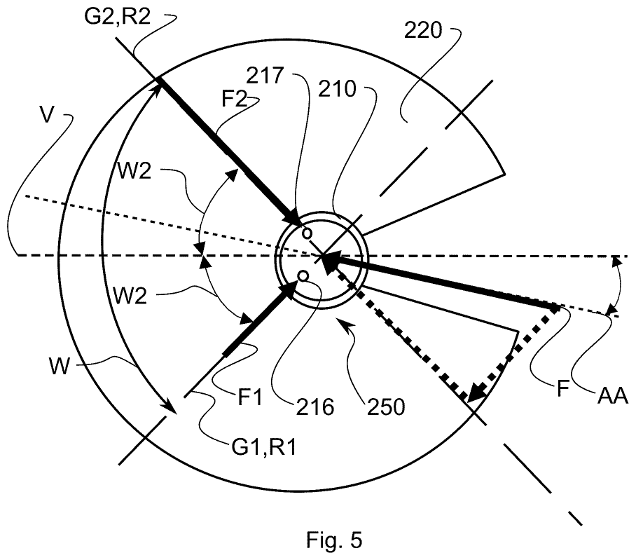

The trailer vehicle 201 according to FIG. 1 has a measuring system 260 for measuring an articulation angle A (see FIGS. 3 and 5). The measuring system 260 includes a measuring device 250 having a sensor device 215 and includes a controller 255 connected to the sensor device 215.

The multi-unit vehicle 200 and the features of the fifth-wheel coupling 205, of the measuring system 260, of the measuring device 250 and of the controller 255 are described further with reference to FIGS. 2 to 5.

FIG. 2 shows a further schematic illustration of a side view of a multi-unit vehicle 200 including a trailer vehicle 201 according to an aspect of the disclosure. FIG. 2 is described with reference to FIG. 1. Here, the towing vehicle 202 and the trailer vehicle 201 are illustrated separately from each other in order to illustrate the configuration and the function of the fifth-wheel coupling 210.

The trailer vehicle 201 includes a kingpin 210. The kingpin 210 and the fifth-wheel coupling 205 are configured to be brought into operative connection with each other in order that the towing vehicle 202 can pull or more generally move the trailer vehicle 201.

When the trailer vehicle 201 and/or the towing vehicle 202 are/is moving, forces F can act between the towing vehicle 201 and the trailer vehicle 201, for example owing to a difference in the accelerations of the towing vehicle 201 and the trailer vehicle 201. The forces F between the towing vehicle 201 and the trailer vehicle 201 cause and/or are forces F on the kingpin 210. For example, a force F acting in the direction of the towing vehicle 205 acts on the kingpin 210 in the event of relative acceleration of the towing vehicle 201; a force F acting in the direction of the trailer vehicle 201 acts on the kingpin in the event of relative braking of the towing vehicle 201. The kingpin 210 has an elasticity and is therefore deformable by the force F. The force F results in a deflection D of the kingpin 210.

The trailer vehicle 201 includes the measuring system 260 for measuring the deflection D of the kingpin 210 in two directions R1, R2 caused by the force F between the towing vehicle 202 and the trailer vehicle 201 (see FIGS. 3 and 5). It is therefore possible to measure the deformation in the kingpin 210 in two directions R1, R2 and therefore to detect the radial forces or horizontal forces, in particular in a plane spanned by the directions R1, R2, between the towing vehicle 202 and the trailer vehicle 201. In this way, it is then possible to control the braking forces of the trailer vehicle 201 and/or an electric drive 207 of the trailer vehicle 201, and an electrical driveable axle 203 of the trailer vehicle 201 can thus be controlled (see FIG. 3). For this purpose, the trailer vehicle 201 has a brake system 206 and an electric drive 207, which are connected in terms of communication to the controller 255 of the measuring system 260 (not shown).

FIG. 3 shows a schematic illustration of a top view of a multi-unit vehicle 200 including a trailer vehicle 201 according to an aspect of the disclosure. FIG. 3 is described with reference to FIGS. 1 and 2.

The multi-unit vehicle 200 or the towing vehicle 202 and/or the trailer vehicle 201 have a forward direction of travel V (also see FIG. 2). The forward direction of travel V is the direction of travel of the multi-unit vehicle 200 without a change in direction and can coincide with a longitudinal axis of the multi-unit vehicle 200 or the towing vehicle 202 and/or the trailer vehicle 201.

The towing vehicle 202 can rotate about a vertical axis (schematically indicated by a circle containing a cross in the towing vehicle 202) due to a steering movement and/or during braking. In the process, an articulation angle A can be established. The articulation angle A is the angle between the forward direction of travel V and a trailer vehicle longitudinal axis AA, that is, a longitudinal axis of the trailer vehicle 201. The trailer vehicle longitudinal axis AA corresponds to a straight line which connects a center of gravity of the trailer vehicle 201 (schematically indicated by a circle containing a cross in the trailer vehicle 201) and the kingpin 210.

The trailer vehicle 201 has an electrical driveable axle 203 and an electric drive 207. The electric drive 207 can be configured for regenerative braking. The electric drive 207 can therefore apply a braking and/or drive torque to wheels of the driveable axle 203 (schematically shown by double-headed arrows).

By accelerating, braking and/or steering the towing vehicle 202 and/or driving and/or braking one or more wheels of the driveable axle 203 of the trailer vehicle 201, a force F can act between the trailer vehicle 201 and the towing vehicle 202. In this case, the force F acts on the kingpin 210, on which the sensor device 210 is provided.

The controller 255 is configured to determine an articulation angle A between the towing vehicle 202 and the trailer vehicle 201 on the basis of the deflection D of the kingpin 210 in the two directions R1, R2. In this case, the controller 255 is configured in particular to determine the articulation angle A as a function of a quotient of a first deflection D1 in a first direction R1 of the two directions R1, R2 and a second deflection D2 in a second direction R2 of the two directions R1, R2 and an inverse trigonometric function of the quotient (see FIG. 5 and the description thereof).

FIG. 4 shows a schematic sectional illustration of a measuring device 250 as per an embodiment according to an aspect of the disclosure. The measuring device 250 is a measuring device 250 for a trailer vehicle 201 for determining an articulation angle A between a towing vehicle 202 and the trailer vehicle 201. A trailer vehicle 201 of this kind is described with reference to FIGS. 1 to 3. FIG. 4 is described with reference to FIGS. 1 to 3.

The measuring device 250 according to FIG. 4 includes the kingpin 210 and the sensor device 215.

The trailer vehicle 201 includes a skid plate 220 and the kingpin 210 includes a fastening flange 221. The trailer vehicle 201 has a plurality of screw connections 225, with which the kingpin 210 is mounted on the skid plate 220 of the trailer vehicle 201 by way of the fastening flange 221.

The skid plate 220 rests on the fifth-wheel coupling 205 of the towing vehicle 201 and the kingpin 210 engages into the fifth-wheel coupling 205.

The sensor device 215 is configured to measure a deflection D of the kingpin 210 in two directions R1, R2 caused by the force F between the towing vehicle 202 and the trailer vehicle 201. The deflection D of the kingpin 210 is an in particular elastic deformation of the kingpin 210 in this case. Owing to the action of the force F, the kingpin 210 can be deformed in such a way that the kingpin 210 is displaced perpendicularly to its longitudinal axis A in sections. In this case, two directions R1, R2 of the deflection D or of the force F can be measured in order to determine the deflection D or the force F and/or the components thereof in a comprehensive manner. For this purpose, the sensor device 215 has two sensor elements 216, 217 for measuring the deflection D in one of the two directions R1, R2 in each case.

The kingpin 210 has two openings 211, 212, and the sensor device 215 and/or the sensor elements 216, 217 or the components thereof are/is partially arranged in the opening 211, 212 and at one end 112a of the respective opening 211, 212. Here, each of the sensor elements 216, 217 is assigned to one of the openings 211, 212. One of the sensor elements 216, 217 is partially arranged in one of the openings 211, 212 in each case.

The openings 211, 212 are each blind holes or blind bores in the kingpin 210. The openings 211, 212 each have a diameter d of 3 mm to 6 mm.

The kingpin 210 has a pin shank 218 and the openings 211, 212 are arranged within the pin shank 218. The kingpin 210 has a pin head 219 and the openings 211, 212 extend through the pin shank 218 into the pin head 219. Here, the openings 211, 212 are each cylindrical and therefore each define a main direction of extent along a cylinder axis of the respective opening 211, 212. The openings 211, 212 are arranged so as to extend parallel to the longitudinal axis A in the main direction of extent.

The kingpin 210 has a neutral axis 214 and the openings 211, 212 are arranged outside the neutral axis 214. Here, the neutral axis 214 is drawn merely schematically outside the longitudinal axis A. The neutral axis 214 can coincide with the longitudinal axis A.

The measuring device 250 has, in each of the openings 211, 212, a transmission element 117 and a pressure sensor 115b as one of the sensor elements 216, 217. In other words, each of the sensor elements 216, 217 includes a transmission element 117 and a pressure sensor 115b.

The pressure sensor 115b of each sensor element 216, 217 has a deformable diaphragm 119 and the respective transmission element 117 is a pressure rod 117′ which is supported on the pressure sensor 115 and is thread-free in sections and has a curved head 119a as the spherical end of the pressure rod 117′ for interacting with the diaphragm 119. The pressure rod 117′ is composed, for example, of metal or another suitable elastically deformable material. A deflection of the kingpin 210 results in a deflection of the pressure rod 117′, which can manifest itself in compressive or tensile stress. Owing to the compression or tension, the head 119a of the compression rod 117′ interacts mechanically with the diaphragm 119. The interaction between the head 119a of the pressure rod 117′ and the diaphragm 119 leads to a deformation of the diaphragm 119 and thus to a pressure which can be measured as an electrical signal by the respective pressure sensor 115b. The transmission element 117 has a preload when the kingpin 210 is in an undeformed state.

Since it is possible to measure a deflection of the kingpin 210 using the two mutually independent sensor elements 216, 217, the sensor device 215 is configured to determine a deflection D in the two directions R1, R2 of the kingpin 210 caused by a radial force F.

The sensor device 215 has an electronic interface 116 for each sensor element 216, 217 for connecting the sensor device 215 or the respective sensor element 216, 217 to the controller 255, to the brake system 206 and/or to the electric drive 207 in terms of communication. The sensor device 215 outputs, for example, an analog signal which corresponds to the pressure and therefore directly to the deflection of the kingpin 210. The force F and/or deflection D in one of the directions R1, R2 can be determined on the basis of the pressures of the two sensor elements 216, 217 in each case.

As an alternative to the pressure rod 117′ as the transmission element 177, a transmission fluid can be provided in one or more of the openings 211, 212, wherein a change in pressure can result from a change in volume of the opening 211, 212 when the kingpin 210 is deflected. As an alternative to the pressure rod 117′ as the transmission element 177, a strain gauge can furthermore be arranged in one or more of the openings 211, 212.

FIG. 5 shows a schematic illustration of a measuring device 250 as per an embodiment according to an aspect of the disclosure and acting and measurable forces F. A measuring device 250 of this kind is described with reference to FIGS. 1 to 4. FIG. 5 is described with reference to FIGS. 1 to 4.

According to FIG. 5, the measuring device 250 is configured to measure the force F in the two directions R1, R2. The measuring device 250 has the two sensor elements 216, 217 for this purpose. Here, each of the sensor elements 216, 217 is configured to measure the deflection D or the force F in one of the two directions R1, R2 in each case.

A straight line G1, G2 is arranged between each of the sensor elements 216, 217 and the kingpin 210 or the center point thereof (not indicated), each straight line being associated with one of the sensor elements 216, 217. The straight line G1, G2 of the respective sensor element 216, 217 defines the direction R1, R2 in which the sensor element 216, 217 can detect the deflection D or the force F, that is, the component of the deflection D or the force F. The first direction R1 is arranged parallel to the first straight line G1 and the second direction R2 is arranged parallel to the second straight line G2.

The two directions R1, R2 enclose an angle W of 90° with each other. In other words, the two straight lines G1, G2 between the sensor elements 216, 217 enclose an angle of 90° with each other.

The two sensor elements 216, 217 are arranged in such a way that each of the straight lines G1, G2 between the kingpin 210 and the respective sensor element 216, 217 encloses a second angle W2 of 45° with the forward direction of travel V. In another embodiment, the second angle W2 can have a different value and/or can be different for each of the straight lines G1, G2 or for each of the sensor elements 216, 217.

The first sensor element 216 is configured to measure a first force F1 as a component of the force F between the trailer vehicle 201 and the towing vehicle 202, the first force acting along the first direction R1. The second sensor element 217 is configured to measure a second force F2 as a component of the force F between the trailer vehicle 201 and the towing vehicle 202, the second force acting along the second direction R2.

The force F can be broken down into components (see arrows with a dotted line), which can be measured as the first force F1 and the second force F2, by two sensor elements 216, 217.

The following applies for the force F: F=F1·cos(W2+A)+F2·cos(W2−A) and with the second angle W2 of 45° the articulation angle A is: A=arctan(F1/F2)−45°, where cos is the cosine function and arctan is the arctangent function, that is, an inverse trigonometric function. Here, the argument of the arctangent function is a quotient of the first force F1 and the second force F2 and is equal to a quotient of the force F in the first direction R1 and the force F in the second direction R2 and therefore to a quotient of the deflection D in the first direction R1 and the deflection D in the second direction R2. At least one specification heading is required.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

115b Pressure sensor
116 Electronic interface
117 Transmission element
117′ Pressure rod
118 Metal housing
119 Diaphragm
119a Head
200 Multi-unit vehicle
201 Trailer vehicle
202 Towing vehicle
203 Driveable axle
205 Fifth-wheel coupling
206 Braking system
207 Drive
210 Kingpin
211 First opening
212 Second opening
214 Neutral axis
215 Sensor device
216 First sensor element
217 Second sensor element
218 Pin shank
219 Pin head
220 Skid plate
221 Fastening flange
225 Screw connection
250 Measuring device
255 Controller
260 Measuring system
A Articulation angle
AA Trailer vehicle longitudinal axis
d Diameter
D Deflection
D1 First deflection
D2 Second deflection
F Force
F1 Force in the first direction
F2 Force in the second direction
G1 First straight line
G2 Second straight line
L Longitudinal axis
R1 First direction
R2 Second direction
V Forward direction of travel
W Angle
W2 Second angle

1. A measuring device for a trailer vehicle for determining an articulation angle between a towing vehicle and the trailer vehicle, the measuring device comprising:
a kingpin; and,
a sensor device configured to measure a deflection of said kingpin in two directions caused by a force between the towing vehicle and the trailer vehicle.

2. The measuring device of claim 1, wherein the two directions mutually enclose an angle of 80° to 100°.

3. The measuring device of claim 1, wherein said sensor device has two sensor elements, each of said two sensor elements being configured to measure the deflection in one of the two directions.

4. The measuring device of claim 3, wherein:
the trailer vehicle defines a forward direction of travel; and,
said two sensor elements are arranged such that a straight line between said kingpin and one of said two sensor elements encloses a second angle of 40° to 50° with the forward direction of travel.

5. The measuring device of claim 1, wherein:
said kingpin defines two openings and said sensor device is arranged in said two openings; and,
at least one of:
said kingpin defines a longitudinal axis and said two openings are arranged parallel to the longitudinal axis, and,
said kingpin defines a neutral axis and said two openings are each arranged outside the neutral axis.

6. The measuring device of claim 5, wherein said kingpin has a pin shank and said two openings are arranged within said pin shank.

7. The measuring device of claim 6, wherein said kingpin has a pin head and said two openings each extend through said pin shank into said pin head.

8. A measuring system for a trailer vehicle, the measuring system comprising:
a measuring device for determining an articulation angle between a towing vehicle and the trailer vehicle, the measuring device including a kingpin and a sensor device configured to measure a deflection of said kingpin in two directions caused by a force between the towing vehicle and the trailer vehicle;
a controller connected to said sensor device; and,
said controller being configured to determine, on a basis of the deflection of said kingpin in the two directions, the articulation angle between the towing vehicle and the trailer vehicle.

9. The measuring system of claim 8, wherein said controller is configured to determine the articulation angle as a function of a quotient of a first deflection in a first direction of the two directions and a second deflection in a second direction of the two directions and/or an inverse trigonometric function of the quotient.

10. A trailer vehicle comprising the measuring device of claim 1.

11. A trailer vehicle comprising the measuring system of claim 8.
